(19) United States
(12) Patent Application Publication
(10) Pub. No.: US 2019/0340676 A1
(43) Pub. Date: Nov. 7, 2019

(54) ONLINE SHOPPING PLATFORM PROVIDED WITH POS SYSTEM BY MEANS OF WORLD WIDE WEB

(71) Applicant: TRUSTED SOLUTIONS CORPORATION, New Taipei City (TW)

(72) Inventor: KUANG HUNG CHENG, NEW TAIPEI CITY (TW)

(21) Appl. No.: 15/969,352

(22) Filed: May 2, 2018

(51) Int. Cl. G06Q 30/06; G06Q 20/20; G06Q 10/08

(52) U.S. Cl. CPC G06Q 30/0641; G06Q 10/0875; G06Q 20/202

(57) ABSTRACT

An online shopping platform provided with a POS system by means of World Wide Web for physical stores to execute the POS system includes: an online shopping mall, having a POS system and an online shopping cart system, the POS system having a store checkout system, an inventory system and an accounting system; a plurality of physical stores, connected with the registered POS system with the browser of a store computer, the store checkout system updating the data of the inventory system and the accounting system according to a checkout message; and a plurality of shopping electronic devices, connected with the online shopping cart system via a network, the shopping electronic device being provided with an online shopping page registered by the consumer and updating the data of the inventory system and the accounting system according to a purchase message.

### FIELD OF THE INVENTION

The present invention relates to a shopping platform, and more particularly to an online shopping platform for a plurality of physical stores to execute a POS system.

### BACKGROUND OF THE INVENTION

In order to enhance operational efficiency and reduce the probability of human errors, the process managements of most restaurants, catering services, supermarkets, logistics industry and other industry are electronized as the main trend of development. Through reliable information management equipment and program applications, the cost can be reduced and the management is effective, thereby improving the efficiency of the process managements of enterprises. Thus, how to effectively use the advantages of speediness and low error rate of electronization and information is a major topic for the management, and the use of a POS system becomes the key point of success and failure.

The operation of a general physical store, such as catering services, is to order food, have a meal or take the purchased goods at the store and then pay at the counter. A POS (Point of Sale) system is used as a store entity shopping interface 90 for assisting a physical store in operation. As shown in FIG. 1A, the store entity shopping interface 90 includes a store entity inventory system 901. The store entity inventory system 901 is connected with a store host 902. The store host 902 is connected with a cash register 910, a printer 904, a barcode scanner 905, a credit card reader 906, an invoice machine 907, a magnetic card reader 908 and the like to assist the collection and related management. The physical store may be a single store or a branch of a single manufacturer, which may be catering or retail. At the counter, machines and cashiers are responsible for the work of point of sale, such as printing invoices and receipts, swiping card, scanning barcode, etc., so that the operation of the POS system can be performed. The inventory status can be known and managed through the store entity inventory system 901.

Because the Internet is widely used, online shopping malls are prosperous in these days. Online shopping transactions can be made with electronic devices such as mobile phones and tablet computers. As shown in FIG. 1B, an online shopping mall 91 includes an online shopping mall inventory system 911. A consumer shopping interface 92 is connected with the online shopping mall 91 through a network 93 for online shopping transactions. The online shopping mall 91 is an online shopping website. This shopping website may be a single company website or a shopping platform, such as Amazon, Alibaba, Shopee, etc. Goods can be purchased via credit cards, virtual currency, points, or any possible online payment. The consumer shopping interface 92 is an electronic device, such as a mobile phone, a tablet, or a computer. The online shopping mall is usually a membership system. The online shopping mall 91 learns its inventory status through the online shopping mall inventory system 911 for management.

The aforementioned two kinds of shopping interfaces: the store entity shopping interface 90 and the consumer shopping interface 92 are operated separately. The store entity shopping interface 90 and the consumer shopping interface 92 have their own store entity inventory system 901 and the online shopping mall inventory system 911, respectively. It is obviously difficult to manage the two inventory systems.

Accordingly, the inventor of the present invention has devoted himself based on his many years of practical experiences to solve these problems.

### SUMMARY OF THE INVENTION

The primary object of the present invention is to provide an online shopping platform provided with a POS (point of sale) system by means of World Wide Web for a plurality of physical stores to execute the POS system, which enables the physical stores to work together with the online shopping mall, actively achieves the characteristics of combining the two to operate, and effectively improves the efficiency and flexibility of using the POS system.

In order to achieve the above object and effect, the online shopping platform of the present invention comprises an online shopping mall, a plurality of physical stores, and a plurality of shopping electronic devices. The online shopping mall is a website store platform. The online shopping mall has a POS system and an online shopping cart system. The POS system has a plurality of dedicated POS subsystems. Each dedicated POS subsystem provides registration and dedicated use for any one of the physical stores. The online shopping cart system has a plurality of personal shopping cart subsystems. Each personal shopping cart subsystem is to provide any one of the shopping electronic devices for online shopping. Each dedicated POS subsystem has a store checkout system, an inventory system, and an accounting system. The store checkout system is connected with the inventory system and the accounting system, respectively. Each personal shopping cart subsystem is connected with the inventory system and the accounting system of each dedicated POS subsystem. Each physical store is any personal store or any enterprise store. The physical store includes at least one Internet-enabled store computer device. The store computer device has a browser. The store computer device uses the browser as an interface to connect to a registered one of the dedicated POS subsystems of the online shopping mall, that is, the dedicated POS subsystem corresponding to the physical store device and to connect to the store checkout system of the dedicated POS subsystem. When the store computer device of the physical store uses the browser as an interface to connect to the dedicated POS subsystem and clicks the webpage of the dedicated POS subsystem and executes the checkout operation of the POS system, the store checkout system generates a checkout message and transmits the checkout message to the browser of the store computer device of the physical store so that the physical store knows the checkout message. The store checkout system synchronously updates the data of the inventory system and the accounting system of the dedicated POS subsystem according to the checkout message. Each shopping electronic device is connected with the online shopping cart system of the online shopping mall via a network and is connected to a registered and dedicated one of the personal shopping cart subsystems. The shopping electronic device has an online shopping page and connects with the personal shopping cart subsystem through the online shopping page of the shopping electronic device. The online shopping page is displayed and operated according to the registered personal shopping cart subsystem. After the online shopping page completes the selection of merchandise, the online shopping page generates a merchandise message of the selected merchandise and the merchandise message is transmitted to the personal shopping cart subsystem. The personal shopping cart subsystem records the merchandise message to complete a merchandise list and displays the merchandise list on the online shopping page. After the online shopping page completes the checkout payment of the merchandise list, the online shopping page generates a purchase message and transmits the purchase message to the personal shopping cart subsystem. The purchase message includes a merchandise message of the paid merchandise on the online shopping page. The merchandise message includes a merchandise number, a merchandise name, a merchandise quantity, a merchandise unit price, a customer name, and a customer requirement. The merchandise number contains the message that the merchandise is sold by the dedicated POS subsystem. The personal shopping cart subsystem synchronously updates the data of the dedicated POS subsystem belonging to each of the merchandise in the purchase message according to the purchase message, that is, the personal shopping cart subsystem updates the merchandise quantity of the inventory system and updates the collection of the accounting system. Thereby, for any of the physical stores, the checkout message of the store checkout system and the purchase message of the online shopping page are operated on the same online shopping platform, so that physical store shopping and online shopping can use the inventory system and the accounting system of the store checkout system.

Preferably, the store computer device further connects a plurality of peripheral devices. The peripheral devices include all or some of a cash drawer, a printer, a barcode scanner, a credit card reader, an invoice machine and a magnetic card reader, but not limited thereto.

Preferably, the online shopping page of the shopping electronic device is provided by the online shopping mall in the form of a webpage interface after the shopping electronic device is connected with the online shopping mall through a browser.

Preferably, the shopping electronic device is connected with the online shopping mall to download an APP (mobile application) from the online shopping mall, and the online shopping page of the shopping electronic device is provided by the APP after the shopping electronic device installs the APP.

Preferably, the checkout message includes a merchandise number, a merchandise name, a merchandise quantity, a merchandise unit price, a customer name, and a customer requirement of the paid merchandise. Wherein, the merchandise number contains the message that the merchandise is sold by the dedicated POS subsystem. The store checkout system can update the merchandise quantity of the inventory system and update the collection of the accounting system according to the checkout message.

Preferably, the customer requirement of the checkout message include a merchandise packaging requirement, a sweet and spicy requirement for food, or a reservation requirement for dining, but not limited thereto. The physical store finishes the complete customer service for the merchandise according to the customer requirement.

Preferably, the customer requirement of the purchase message include a merchandise packaging requirement, a sweet and spicy requirement for food, or a reservation requirement for dining, but not limited thereto. The physical store finishes the complete customer service for the merchandise according to the customer requirement.

Preferably, the store computer device has a data synchronization mechanism that actively detects the checkout message and the merchandise message belonging to the dedicated POS subsystem corresponding to the physical store in the purchase message in real time. The data synchronization mechanism that enables the store computer device to actively check the messages is that the browser of the store computer device can check the checkout message generated by the store checkout system by connecting to the store checkout system. The browser of the store computer device connects to the store checkout system and connects to the accounting system through the store checkout system. The update of the collection of the accounting system can check the merchandise message belonging to the dedicated POS subsystem corresponding to the physical store in the purchase message, so that the store computer device can get hold of the trading situation of the online shopping mall in real time.

Preferably, the store computer device has a data synchronization mechanism that passively receives the checkout message and the merchandise message belonging to the dedicated POS subsystem corresponding to the physical store in the purchase message in real time. The data synchronization mechanism that enables the store computer device to passively receive the messages is that the store checkout system synchronously transmits the checkout message generated by the store checkout system to the browser so that the browser receives the checkout message. Through the connection of the accounting system and the store checkout system, the accounting system synchronously transmits the updated message of the collection of the accounting system to the store checkout system. Through the connection of the store checkout system and the browser, the store checkout system synchronously transmits the updated message of the collection of the accounting system to the browser, so that the browser receives the updated message of the collection of the accounting system, that is, the browser receives the merchandise message belonging to the dedicated POS subsystem corresponding to the physical store in the purchase message, so that the store computer device can get hold of the trading situation of the online shopping mall in real time.

Preferably, the accounting system and the inventory system are stored in a cloud storage server system.

Preferably, the shopping electronic device or the Internet-enabled store computer device of the physical store is a combination or one of a mobile phone, a tablet computer, a notebook computer and a desktop computer.

Preferably, the online shopping cart system is further connected with an auditing unit for auditing the purchase of the merchandise list on the online shopping page.

In order to more clearly understand the technical features and effects achieved by the present invention, the following further describes the present invention in detail with reference to the accompanying drawings and specific embodiments.

### BRIEF DESCRIPTION OF THE DRAWINGS

FIG. 1A is a block diagram of a physical store of a conventional POS system;

FIG. 1B is a schematic view of a conventional online shopping mall; and

FIG. 2 is a schematic view of an online shopping mall in accordance with the present invention.

### DESCRIPTION OF THE PREFERRED EMBODIMENTS

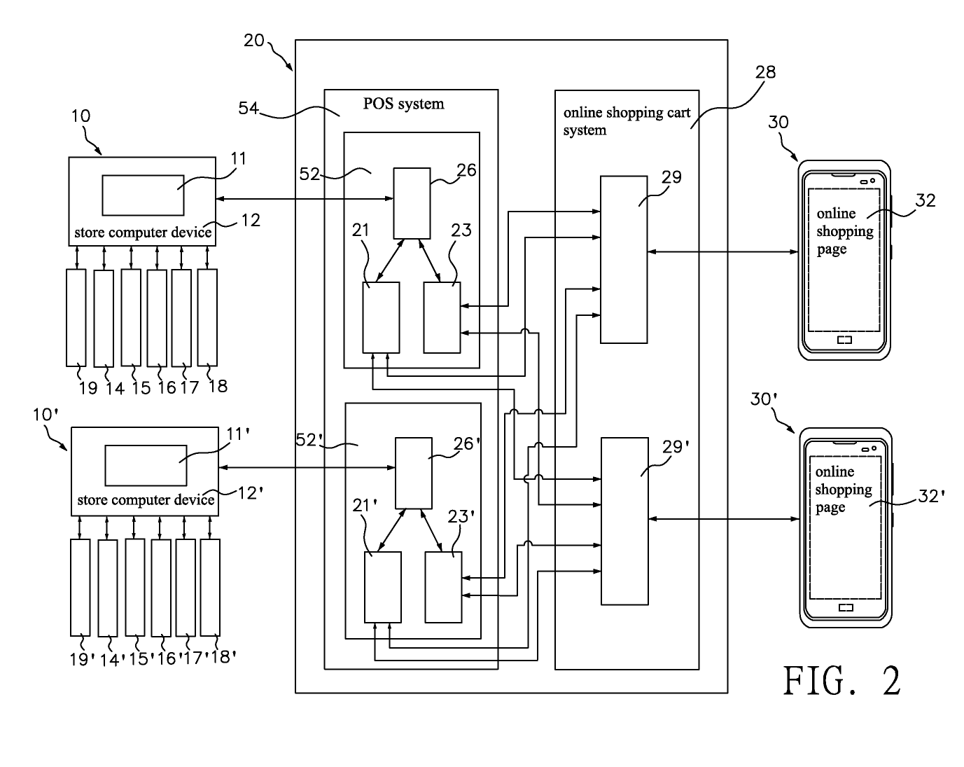

FIG. 2 illustrates an online shopping platform provided with a POS (point of sale) system via World Wide Web for a plurality of physical stores 10 to execute the POS system. The online shopping platform comprises an online shopping mall 20, a plurality of physical stores 10, and a plurality of shopping electronic devices 30.

The online shopping mall 20 is a website store platform. The online shopping mall 20 has a POS system 54 and an online shopping cart system 28. The POS system 54 has a plurality of dedicated POS subsystems 52. Each dedicated POS subsystem 52 provides registration and dedicated use for any one of the physical stores 10. The online shopping cart system 28 has a plurality of personal shopping cart subsystems 29. Each personal shopping cart subsystem 29 is to provide any one of the shopping electronic devices 30 for online shopping. Each dedicated POS subsystem 52 has a store checkout system 26, an inventory system 21, and an accounting system 23. The store checkout system 26 is connected with the inventory system 21 and the accounting system 23, respectively. Each personal shopping cart subsystem 29 is connected with the inventory system 21 and the accounting system 23 of each dedicated POS subsystem 52.

Each physical store 10 is any personal store or any enterprise store. Each physical store 10 includes at least one Internet-enabled store computer device 12. The store computer device 12 has a browser 11. The store computer device 12 uses the browser 11 as an interface to connect to a registered one of the dedicated POS subsystems 52 of the online shopping mall 20, that is, the dedicated POS subsystem 52 corresponding to the store computer device 12 and connect to the store checkout system 26 of the dedicated POS subsystem 52. When the store computer device 12 of the physical store 10 uses the browser 11 as an interface to connect to the dedicated POS subsystem 52 and clicks the webpage of the dedicated POS subsystem 52 and executes the checkout operation of the POS system 54, the store checkout system 26 generates a checkout message and transmits the checkout message to the browser 11 of the store computer device 12 of the physical store 10 so that the physical store 10 knows the checkout message. The store checkout system 26 synchronously updates the data of the inventory system 21 and the accounting system 23 of the dedicated POS subsystem 52 according to the checkout message.

Wherein, the Internet-enabled store computer device 12 may be a combination or one of a mobile phone, a tablet computer, a notebook computer and a desktop computer, but not limited thereto.

Wherein, the store computer device 12 of the physical store 10 may connect a plurality of peripheral devices to assist in executing the dedicated POS subsystem 52, and may directly execute the dedicated POS subsystem 52 without connecting peripheral devices, so that the browser 11 can perform the checkout operation of the dedicated POS subsystem 52. For example, if there is an additional screen display requirement, a monitor or screen can be connected. If there is a need to print an invoice or receipt, a printer 14 or an invoice machine 17 can be connected. If there is a need to connect a payment sensor device, a credit card reader 16 or the magnetic card reader 18 can be connected. If there is a demand for cash management, a cash drawer 19 can be connected. If there is a need for barcode recognition, a barcode scanner 15 can be connected. The type and quantity of the actual connected peripheral devices can be arranged according to the on-site demand of each physical store 10. Even without connecting any peripheral device, the process of checkout and collection can be completed. That is, the store computer device 12 may be connected with a plurality of peripheral devices. The peripheral devices may include all or some of a cash drawer 19, a printer 14, a barcode scanner 15, a credit card reader 16, an invoice machine 17 and a magnetic card reader 18, but not limited thereto.

The physical store 10 may be a single store or branch of a single manufacturer, and may be catering or retail. The cashier may perform sales work with the store computer device 12 and a plurality of peripheral devices, such as printing an invoice, a receipt, or swiping a card, or scanning a barcode, etc., in order to achieve operations of the information management and sales management.

The checkout message includes, for example, a merchandise number, a merchandise name, a merchandise quantity, a merchandise unit price, a customer name, and a customer requirement of the paid merchandise. Wherein, the merchandise number contains the message that the merchandise is sold by the dedicated POS subsystem. Therefore, the store checkout system 26 can update the merchandise quantity of the inventory system 21 and update the collection of the accounting system 23 according to the checkout message. The customer requirement of the checkout message includes a merchandise packaging requirement, a sweet and spicy requirement for food, or a reservation requirement for dining, but not limited thereto. The physical store 10 finishes the complete customer service for the merchandise according to the customer requirement.

Wherein, the store computer device 12 of the physical store 10 uses the browser 11 as an interface and clicks the webpage of the store checkout system 26 of the dedicated POS subsystem 52 to execute the checkout operation of the POS system 54. It is not limited by an operating system, that is, it can be executed by Windows, Mac, Linux, iOS and other operating systems to achieve the use of a cross-platform. In this operation, the physical store 10 does not need to download the software of the dedicated POS subsystem 52, and does not need to install the dedicated POS subsystem 52, and does not need to upgrade the dedicated POS subsystem 52. Clicking the webpage of the store checkout system 26 of the dedicated POS subsystem 52 can execute the checkout operation of the POS system, which is very simple to use and does not have a maintenance burden.

Wherein, the inventory system 21 and the accounting system 23 are stored in a cloud storage server system. In this way, input data, output data, and calculation results can be stored in real time and can be simultaneously applied to the inventory system 21 and the accounting system 23 of the online shopping mall 20.

Each shopping electronic device 30 is connected with the online shopping cart system 28 of the online shopping mall 20 via a network, and is connected to a registered and dedicated one of the personal shopping cart subsystems 29 of the shopping electronic device 30. The shopping electronic device 30 has an online shopping page 32 and connects with the personal shopping cart subsystem 29 through the online shopping page 32 of the shopping electronic device 30. The online shopping page 32 is displayed and operated according to the registered personal shopping cart subsystem 29. After the online shopping page 32 completes the selection of merchandise, the online shopping page 32 generates a merchandise message of the selected merchandise. The merchandise message is transmitted to the personal shopping cart subsystem 29. The personal shopping cart subsystem 29 records the merchandise message to complete a merchandise list and displays the merchandise list on the online shopping page 32. After the online shopping page 32 completes the checkout payment of the merchandise list, the online shopping page 32 generates a purchase message and transmits the purchase message to the personal shopping cart subsystem 29. The purchase message includes a merchandise message of each of the paid merchandise on the online shopping page 32. The merchandise message includes a merchandise number, a merchandise name, a merchandise quantity, a merchandise unit price, a customer name, and a customer requirement. The merchandise number contains the message that the merchandise is sold by the dedicated POS subsystem. The personal shopping cart subsystem 29 synchronously updates the data of the dedicated POS subsystem 52 belonging to each of the merchandise in the purchase message according to the purchase message, that is, the personal shopping cart subsystem 29 updates the merchandise quantity of the inventory system 21 and update the collection of the accounting system 23.

Wherein, the shopping electronic devices 30 may be a combination or one of a mobile phone, a tablet computer, a notebook computer and a desktop computer, but not limited thereto.

The customer requirement of the purchase message includes a merchandise packaging requirement, a sweet and spicy requirement for food, or a reservation requirement for dining, but not limited thereto. The physical store 10 finishes the complete customer service for the merchandise according to the customer requirement.

Wherein, selectively, the online shopping page 32 of the shopping electronic device 30 is provided by the online shopping mall 20 in the form of a webpage interface after the shopping electronic device 30 is connected to the online shopping mall 20 through a browser.

Wherein, selectively, the shopping electronic device 30 is connected to the online shopping mall 20 to download an APP (mobile application) from the online shopping mall 20, the online shopping page 32 of the shopping electronic device 30 is provided by the APP after the shopping electronic device 30 installs the APP.

Thereby, for any of the physical stores 10, the checkout message of the store checkout system 26 and the purchase message of the online shopping page 32 operate on the same online shopping platform, so that the shopping of the physical store 10 and the online shopping can use the inventory system 21 and the accounting system 23 of the store checkout system 26.

Wherein, the POS system 54 has a plurality of dedicated POS subsystems 52. Each dedicated POS subsystem 52 has an inventory system 21 and an accounting system 23. The data of the plurality of inventory systems 21 can be stored by a database. The store field is used to distinguish different inventory systems 21, or according to the needs of individual stores in conjunction with their tailor-made, data storage, etc. The data of a single inventory system 21 is stored by a single independent database, that is, the storage of the data of the inventory system 21 and the accounting system 23 can be adjusted according to the needs of customers, not limited to the storage of a single database.

The store computer device 12 of the physical store 10 of the present invention has a data synchronization mechanism that immediately gets hold of each checkout message and the merchandise message belonging to the dedicated POS subsystem 52 corresponding to the physical store 10 in each purchase message. The data synchronization mechanism that enables the store computer device 12 to actively check the messages, or the data synchronization mechanism that enables the store computer device 12 to passively receive the messages is described below.

The store computer device 12 has a data synchronization mechanism that actively detects each checkout message and the merchandise message belonging to the dedicated POS subsystem 52 corresponding to the physical store 10 in each purchase message. The data synchronization mechanism that enables the store computer device 12 to actively check the messages is that the browser 11 of the store computer device 12 can check each checkout message generated by the store checkout system 26 by connecting to the store checkout system 26. Besides, the browser 11 of the store computer device 12 connects to the store checkout system 26 and connects to the accounting system 23 through the store checkout system 26. The update of the collection of the accounting system 23 can check the merchandise message belonging to the dedicated POS subsystem 52 corresponding to the physical store 10 in each purchase message, so that the store computer device 12 can get hold of the trading situation of the online shopping mall in real time.

The store computer device 12 has a data synchronization mechanism that passively receives each checkout message and the merchandise message belonging to the dedicated POS subsystem 52 corresponding to the physical store 10 in each purchase message. The data synchronization mechanism that enables the store computer device 12 to passively receive the messages is that the store checkout system 26 synchronously transmits the checkout message generated by the store checkout system 26 to the browser 11 so that the browser 11 receives each checkout message. Through the connection of the accounting system 23 and the store checkout system 26, the accounting system 23 synchronously transmits the updated message of the collection of the accounting system 23 to the store checkout system 26. Through the connection of the store checkout system 26 and the browser 11, the store checkout system 26 synchronously transmits the updated message of the collection of the accounting system 23 to the browser 11, so that the browser 11 receives the updated message of the collection of the accounting system 23. That is, the browser 11 receives the merchandise message belonging to the dedicated POS subsystem 52 corresponding to the physical store 10 in each purchase message, so that the store computer device 12 can get hold of the trading situation of the online shopping mall in real time.

In this way, for certain industries, the physical store 10 can provide online marketing. For example, in the catering industry, consumers can order food online through a shopping electronic device 30 (such as a mobile phone) and then go to the physical store 10 to pick up meals or to dine in the store, and pay the bill.

When a consumer makes a shopping transaction by operating the online shopping page 32 of the shopping electronic device 30, the merchandise can be purchased through a credit card, virtual currency, points, or any other possible online payment means.

Furthermore, the online shopping cart system 28 may further be connected with an auditing unit for auditing the purchase of a merchandise list on the online shopping page 32, including calculating inventory status and checking consumer credit line, etc. If the refusal condition preset by the auditing unit is met, the online shopping mall 20 will send a message of refusing the transaction to the ordering consumer.

In the embodiment of FIG. 2, the physical store 10, the shopping electronic device 30 and the dedicated POS subsystem 52 represent each physical store, each shopping electronic device, and each dedicated POS system. In the embodiment of FIG. 2, the other physical store 10′, the other shopping electronic device 30′, the other dedicated POS subsystem 52′ and the other personal shopping cart system 29′ represent the other physical stores, the other shopping electronic devices, the other dedicated POS systems and the other personal shopping cart systems 29. This is only to show that the present invention can be applied to multiple physical stores, multiple shopping electronic devices, multiple dedicated POS subsystems and multiple personal shopping cart subsystems, not to limit the number. Similarly, the following other components have the same effect: the browser 11′, the store computer device 12′, the printer 14′, the barcode scanner 15′, the credit card reader 16′, the invoice machine 17′, the magnetic card reader 18′, the cash drawer 19′, the inventory system 21′, the accounting system 23′, the store checkout system 26′, and the online shopping page 32′.

The Following is to Illustrate Application Examples:

A first application example is used to illustrate ordering by the Internet. The consumer shops on the online shopping mall 20 via the online shopping page 32 of the shopping electronic device 30, clicks the desired merchandise (may be sushi, beef noodles, fried rice), books a seat, preselects a store, and completes the checkout through the personal shopping cart subsystem 29. Then, the consumer goes to the physical store 10 to pick up a meal, take goods or dine in the store according to the information (it may be a one-dimensional or two-dimensional barcode) left by the checkout.

The invoice and receipt for this transaction can be given to the consumer through the conventional e-commerce operation, such as mailing, keeping the electronic file, or sending the electronic file to the consumer. It can be picked up by the consumer when he/she picks up the merchandise at the store. When the order is received by the store, it is equivalent to completing the checkout of the cash register of the dedicated POS subsystem 52. If the store is a restaurant, the restaurant is ready to prepare the meal.

A second application example is used to illustrate consumption in the physical store 10. The user goes to the physical store 10 to order or checkout directly with the service worker. The service worker directly performs an operation (including ordering meals, booking a seat, etc.) on the browser 11 of the store computer device 12 of the physical store 10, and collects cash, a credit card or third party payment, and prints invoices and receipts.

The foregoing two application examples are completed in the same cloud storage server system, and are completed in the same inventory system 21 and accounting system 23, that is, the online shopping is integrated with the existing physical store 10. There are no longer two operating systems. For example, a consumer can order signature coffee at a specialty coffee shop in Taipei Main Station via the online shopping page 32 of the shopping electronic device 30. Consumers can order coffee and made the payment before they reach the coffee shop, or they can go to the store and order food. The present invention has an online shopping platform provided with a POS system via a web page. No matter whether the consumer shops on the online shopping page 32 of the shopping electronic device 30 or the shopping is performed at the store via the browser 11 of the store computer device 10, both are the same system, the same database, the same inventory system 21 and the same accounting system 23, and the taxes, invoices, and restaurant processes are all the same.

The invention provides an online shopping platform provided with a POS system by means of World Wide Web. This platform keeps the physical store's consumption mode and checkout flow, but it is integrated with the new-style online shopping. Therefore, its advantages include:

1. The operation can be performed via the browser 11 of the stop computer device 12 and the customer's mobile phone (the shopping electronic device 30) for ordering, shopping, and checkout.

2. The consumer can perform the operation by himself/herself and can be served by a clerk.

3. It can be booked remotely, purchased on site, booked on site

Although particular embodiments of the present invention have been described in detail for purposes of illustration, various modifications and enhancements may be made without departing from the spirit and scope of the present invention. Accordingly, the present invention is not to be limited except as by the appended claims.

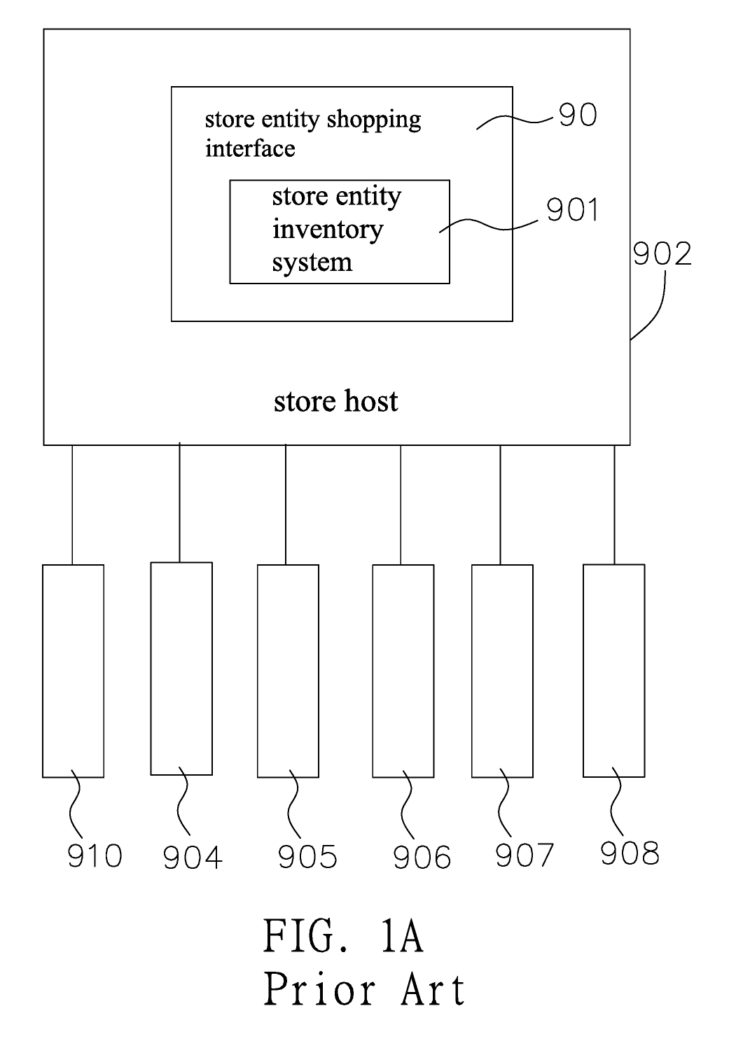

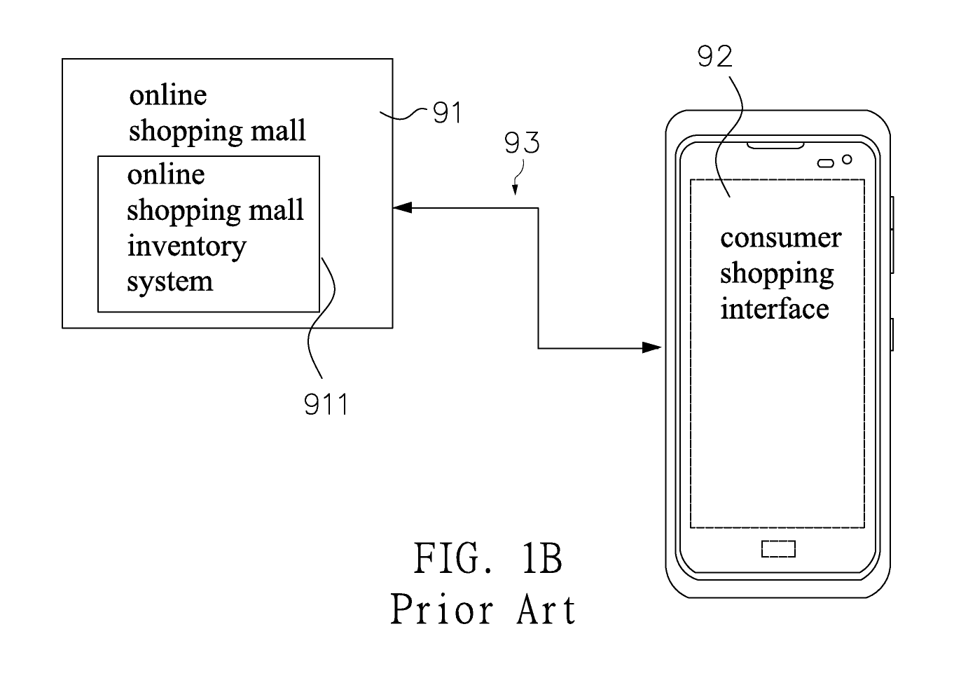

FIG. 1
(90) store entity shopping interface
(901) store entity inventory system
(910) cash register
(904) printer
(905) barcode scanner
(906) credit card reader
(907) invoice machine
(908) magnetic card reader

FIG. 2
(91) online shopping mall
(911) online shopping mall inventory system
(92) consumer shopping interface

FIG. 3
(11) browser
(12) store computer device
(19) cash drawer
(14) printer
(15) barcode scanner
(16) credit card reader
(17) invoice machine
(18) magnetic card reader
(11′) browser
(12′) store computer device
(19′) cash drawer
(14′) printer
(15′) barcode scanner
(16′) credit card reader
(17′) invoice machine
(18′) magnetic card reader
(20) online shopping mall
(21) inventory system
(23) accounting system
(26) store checkout system
(28) online shopping cart system
(29) personal shopping cart subsystem
(52) dedicated POS subsystem
(54) POS system
(21′) inventory system
(23′) accounting system
(26′) store checkout system
(29′) personal shopping cart subsystem
(52′) dedicated POS subsystem
(32) online shopping page
(32′) online shopping page

What is claimed is:

1. An online shopping platform provided with a POS (point of sale) system by means of World Wide Web for a plurality of physical stores to execute the POS system, comprising an online shopping mall, a plurality of physical stores, and a plurality of shopping electronic devices;
the online shopping mall being a website store platform, the online shopping mall having a POS system and an online shopping cart system, the POS system having a plurality of dedicated POS subsystems, each dedicated POS subsystem providing registration and dedicated use for any one of the physical stores, the online shopping cart system having a plurality of personal shopping cart subsystems, each personal shopping cart subsystem being to provide any one of the shopping electronic devices for online shopping, each dedicated POS subsystem having a store checkout system, an inventory system and an accounting system, the store checkout system being connected with the inventory system and the accounting system respectively, each personal shopping cart subsystem being connected with the inventory system and the accounting system of each dedicated POS subsystem;
each physical store being any personal store or any enterprise store, each physical store including at least one Internet-enabled store computer device, the store computer device having a browser, the store computer device using the browser as an interface to connect to a registered one of the dedicated POS subsystems of the online shopping mall, that is, the dedicated POS subsystem corresponding to the physical store and to connect to the store checkout system of the dedicated POS subsystem, wherein when the store computer device of the physical store uses the browser as an interface to connect to the dedicated POS subsystem and clicks the webpage of the dedicated POS subsystem and executes a checkout operation of the POS system, the store checkout system generates a checkout message and transmits the checkout message to the browser of the store computer device of the physical store so that the physical store knows the checkout message, and the store checkout system synchronously updates the data of the inventory system and the accounting system of the dedicated POS subsystem according to the checkout message;
each shopping electronic device being connected with the online shopping cart system of the online shopping mall via a network and being connected to a registered and dedicated one of the personal shopping cart subsystems, the shopping electronic device having an online shopping page and connected with the personal shopping cart subsystem through the online shopping page of the shopping electronic device, the online shopping page being displayed and operated according to the registered personal shopping cart subsystem, wherein after the online shopping page completes the selection of merchandise, the online shopping page generates a merchandise message of the selected merchandise and the merchandise message is transmitted to the personal shopping cart subsystem, the personal shopping cart subsystem records the merchandise message to complete a merchandise list and displays the merchandise list on the online shopping page, after the online shopping page completes the checkout payment of the merchandise list, the online shopping page generates a purchase message and transmits the purchase message to the personal shopping cart subsystem, wherein the purchase message includes a merchandise message of the paid merchandise on the online shopping page, the merchandise message includes a merchandise number, a merchandise name, a merchandise quantity, a merchandise unit price, a customer name, and a customer requirement, the merchandise number contains the message that the merchandise is sold by the dedicated POS subsystem, the personal shopping cart subsystem synchronously updates the data of the dedicated POS subsystem belonging to each of the merchandise in the purchase message according to the purchase message, that is, the personal shopping cart subsystem updates the merchandise quantity of the inventory system and updates the collection of the accounting system;
thereby, for any of the physical stores, the checkout message of the store checkout system and the purchase message of the online shopping page being operated on the same online shopping platform, so physical store shopping and online shopping can use the inventory system and the accounting system of the store checkout system.

2. The online shopping platform as claimed in claim 1, wherein the store computer device further connects a plurality of peripheral devices, and the peripheral devices include all or some of a cash drawer, a printer, a barcode scanner, a credit card reader, an invoice machine and a magnetic card reader.

3. The online shopping platform as claimed in claim 1, wherein the online shopping page of the shopping electronic device is provided by the online shopping mall in the form of a webpage interface after the shopping electronic device is connected with the online shopping mall through a browser.

4. The online shopping platform as claimed in claim 1, wherein the shopping electronic device is connected with the online shopping mall to download an APP (mobile application) from the online shopping mall, and the online shopping page of the shopping electronic device is provided by the APP after the shopping electronic device installs the APP.

5. The online shopping platform as claimed in claim 1, wherein the checkout message includes a merchandise number, a merchandise name, a merchandise quantity, a merchandise unit price, a customer name, and a customer requirement of the paid merchandise, wherein the merchandise number contains the message that the merchandise is sold by the dedicated POS subsystem, and the store checkout system can update the merchandise quantity of the inventory system and update the collection of the accounting system according to the checkout message.

6. The online shopping platform as claimed in claim 5, wherein the customer requirement of the checkout message include a merchandise packaging requirement, a sweet and spicy requirement for food, or a reservation requirement for dining, and the physical store finishes the complete customer service for the merchandise according to the customer requirement.

7. The online shopping platform as claimed in claim 1, wherein the customer requirement of the purchase message include a merchandise packaging requirement, a sweet and spicy requirement for food, or a reservation requirement for dining, and the physical store finishes the complete customer service for the merchandise according to the customer requirement.

8. The online shopping platform as claimed in claim 1, wherein the store computer device has a data synchronization mechanism that actively detects the checkout message and the merchandise message belonging to the dedicated POS subsystem corresponding to the physical store in the purchase message in real time, the data synchronization mechanism that enables the store computer device to actively check the messages is that the browser of the store computer device can check the checkout message generated by the store checkout system by connecting to the store checkout system; and the browser of the store computer device connects to the store checkout system and connects to the accounting system through the store checkout system, the update of the collection of the accounting system can check the merchandise message belonging to the dedicated POS subsystem corresponding to the physical store in the purchase message, so that the store computer device can get hold of the trading situation of the online shopping mall in real time.

9. The online shopping platform as claimed in claim 1, wherein the store computer device has a data synchronization mechanism that passively receives the checkout message and the merchandise message belonging to the dedicated POS subsystem corresponding to the physical store in the purchase message in real time, the data synchronization mechanism that enables the store computer device to passively receive the messages is that the store checkout system synchronously transmits the checkout message generated by the store checkout system to the browser so that the browser receives the checkout message; through the connection of the accounting system and the store checkout system, the accounting system synchronously transmits the updated message of the collection of the accounting system to the store checkout system, through the connection of the store checkout system and the browser, the store checkout system synchronously transmits the updated message of the collection of the accounting system to the browser, so that the browser receives the updated message of the collection of the accounting system, that is, the browser receives the merchandise message belonging to the dedicated POS subsystem corresponding to the physical store in the purchase message, so that the store computer device can get hold of the trading situation of the online shopping mall in real time.

10. The online shopping platform as claimed in claim 1, wherein the inventory system and the accounting system are stored in a cloud storage server system.

11. The online shopping platform as claimed in claim 1, wherein the shopping electronic device or the Internet-enabled store computer device of the physical store is a combination or one of a mobile phone, a tablet computer, a notebook computer and a desktop computer.

12. The online shopping platform as claimed in claim 1, wherein the online shopping cart system is further connected with an auditing unit for auditing the purchase of the merchandise list on the online shopping page.
